(19) United States
(12) Patent Application Publication
(10) Pub. No.: US 2002/0172463 A1
(43) Pub. Date: Nov. 21, 2002

(54) Electro-optic grating

(76) Inventor: Alexander B. Romanovsky, San Jose, CA (US)

Correspondence Address: KNOBBE MARTENS OLSON & BEAR LLP, 2040 MAIN STREET, FOURTEENTH FLOOR, IRVINE, CA, 91614, US

(21) Appl. No.: 10/140,520

(22) Filed: May 7, 2002

Related U.S. Application Data
(60) Provisional application No. 60/289,207, filed on May 7, 2001.

(51) Int. Cl. G02B 6/34; G02B 6/26

(52) U.S. Cl. 385/37; 385/39; 385/40

(57) ABSTRACT

An electro-optic arrayed grating comprises an array of waveguides which provide a plurality of optical paths. The array includes a plurality of electro-optic elements disposed along the optical paths. The electro-optic elements control the optical path lengths of the optical paths to multiplex or demultiplex an optical signal.

### PRIORITY APPLICATION

This application claims priority under 35 U.S.C. §119(e) from U.S. Provisional Patent Application No. 60/289,207, filed May 7, 2001 and entitled “Electro-Optic Grating”.

### BACKGROUND OF THE INVENTION

1. Field of the Invention

The present invention relates generally to optical network technology and, in particular, to arrayed waveguide gratings utilizing electro-optic material.

2. Description of the Related Art

Demands for transmitting signals optically is growing at a rapid pace. Optically transmitted signals are typically in digital format, and may be carried through some form of a waveguide such as an optical fiber.

The optical waveguide's capacity to carry data can be increased by coupling a plurality of optical signals into the waveguide. This process is known in the art as multiplexing (MUX). A multiplexed signal can be separated into its constituent signals in a reverse process known as demultiplexing (DEMUX). The process of multiplexing and demultiplexing is typically performed in a system known in the art as dense wavelength division multiplexing (DWDM).

Typically, each of the plurality of optical signals that are multiplexed have a different wavelength relative to the remaining plurality of signals. Multiplexing and demultiplexing rely on a physical principle known as the superposition principle, which essentially states that waves can be combined and separated without loss of information. In the DWDM system, multiplexing is achieved by combining signals of different wavelengths into a single optical fiber. The multiplexed signal is then typically carried over a long distance to a receiving end, where demultiplexing is performed.

Demultiplexing devices in use today commonly rely on an arrayed waveguide grating (AWG) to demultiplex the optical signal. The AWG comprises a first coupler that optically couples the multiplexed signal to an array of waveguides such that each waveguide receives a fraction of the multiplexed signal. As the multiplexed signal travels through each of the waveguides, the fractions travel over path lengths which are different for each waveguide, and therefore the phases of the fractions are different when each fraction arrives at the input of a second coupler. The fractions received by the second coupler are combined inside the second coupler, and interfere constructively and destructively in the same manner as that which occurs in conventional gratings. The effect of such interference is to separate the wavelengths contained in such portions for output on separate outputs of the second coupler.

In order to achieve optimum efficiency of the AWG, the length and position of each waveguide in the array of waveguides must be established with accuracy during fabrication. Furthermore, once fabricated, the optical path length geometry of the array of waveguides is fixed and cannot be altered. Variations in dimension, geometry and refractive index of waveguide material of the AWG, whether from manufacturing tolerances or environmental conditions, may adversely affect the performance of the AWG.

Therefore, there is a need for a method of controlling the transmission of light in the array of waveguides so as to allow a user to tune or otherwise alter the propagation characteristics of the AWG.

### SUMMARY OF THE INVENTION

The aforementioned needs are satisfied by an electro-optic arrayed grating. According to one aspect of the invention, the arrayed grating comprises a first coupler, a second coupler, and an array which provides a plurality of optical paths between the first and the second couplers. The array comprises a plurality of electro-optic elements along the optical paths. The array controls the optical path lengths of the optical paths to permit multiplexing or demultiplexing of an optical signal.

In another aspect of the invention, the electro-optic element comprises an electro-optic material interposed between a pair of electrodes. Preferably, the electro-optic material is a polycrystalline lanthanum-modified lead titanate zirconate (PLZT), and the electrode is an indium tin oxide layer. At least one of the optical paths extends through the electrodes such that an electric field between the electrodes is generally parallel to one of the optical paths.

In still another aspect of the invention, each of the electro-optic elements comprises an electro-optic material interposed between a first and a second set of electrodes that are generally symmetric with respect to each other such that an electric field between the first and second sets of electrodes is generally parallel to one of the optical paths.

In yet another aspect of the invention, each of the electro-optic elements comprises an electro-optic material interposed between a first and a second set of electrodes that are generally symmetric with respect to each other such that an electric field between the first and second sets of electrodes is generally perpendicular to one of the optical paths.

In one aspect of the invention, the array comprises a plurality of waveguides that provide the plurality of optical paths. Each of the plurality of optical paths includes one or more electro-optic elements in line with the waveguide. The electro-optic element provides a variable or a fixed phase delay of the optical signal. In one implementation, the electro-optic element comprising an electro-optic material without electrodes provides the fixed phase delay.

Another aspect of the invention comprises a method of demultiplexing an optical signal comprised of a plurality of wavelengths using an electro-optic arrayed grating. The method comprises distributing the optical signal into a plurality of optical signals, each of which includes the plurality of wavelengths. The method further comprises delaying the plurality of optical signals by propagating the plurality of signals along respective optical paths, wherein at least some of the paths have an optical path length different than other of the paths. The electro-optic material causes each of plurality of signals to be delayed. The method further comprises combining the plurality of delayed signals, such that the delayed signals spatially separate plurality of wavelengths.

In still another aspect of the invention, the physical lengths of the optical paths are substantially equal. Preferably, the signals are delayed by exposing the electro-optic material to an electric field in a direction that is substantially parallel to the direction of propagation of the optical signal through the electro-optic material. Such orientation of the direction of propagation relative to the electric field may be achieved by passing the optical signals through respective electrodes disposed on opposite sides of the electro-optic material. Each of the delays of the delayed signals is adjustable by adjusting a voltage applied between the electrodes. Delaying of the signals includes altering the spatial separation of wavelengths by altering the voltages applied to the electrodes.

In another aspect of the invention, delaying comprises providing an electric field in the electro-optic material, where the electric field is oriented in a direction that is substantially perpendicular to the direction of propagation of the optical signal. Such implementation may be achieved by applying a voltage to electrodes disposed on opposite lateral sides of the electro-optic material.

Another aspect of the invention comprises a phase delay device for introducing phase delay into an optical signal. This device comprises a plurality of electro-optic elements along a path and one or more optical waveguides optically connecting the electro-optic elements together. The electro-optic elements comprise electro-optic material interposed between a pair of electrodes. The electro-optic elements have dimensions such that the optical signal propagating therethrough is unguided within the electro-optic element. The optical waveguide(s) and electro-optical elements together form an optical path for the optical signal. The electro-optic elements control the optical path lengths of the optical paths and the waveguide(s) limit divergence of the optical signal.

### BRIEF DESCRIPTION OF THE DRAWINGS

FIG. 1 is a schematic illustration of a dense wavelength division multiplexing (DWDM) system;

FIG. 2 is a schematic illustration of a demultiplexer;

FIG. 3 is a schematic illustration of an arrayed waveguide grating (AWG) multiplexer, specifically illustrating the various lengths of the waveguides;

FIG. 4A is a schematic illustration of the AWG employing a plurality of electro-optic elements to alter optical path lengths of signals;

FIG. 4B illustrates an embodiment of a delay module comprising two or more electro-optic elements;

FIG. 4C illustrates an alternate embodiment of the AWG employing a combination of fixed and variable delays to alter optical path lengths of signals;

FIG. 5A is a schematic illustration of a single electro-optic element showing a path of the signal and an electric field in the electro-optic element that alters refractive index;

FIG. 5B illustrates another embodiment of the electro-optic element that uses symmetric electrodes disposed at corners of electro-optic material to generate an electric field generally parallel to the direction of propagation of the optical signal;

FIG. 5C illustrates yet another embodiment of the electro-optic element that applies an electrical field generally perpendicular to the direction of propagation of the optical signal, thereby allowing different polarized optical signals to be affected differently; and

FIG. 6 is a side view of the electro-optic element of FIG. 5A.

### DETAILED DESCRIPTION OF THE PREFERRED EMBODIMENT

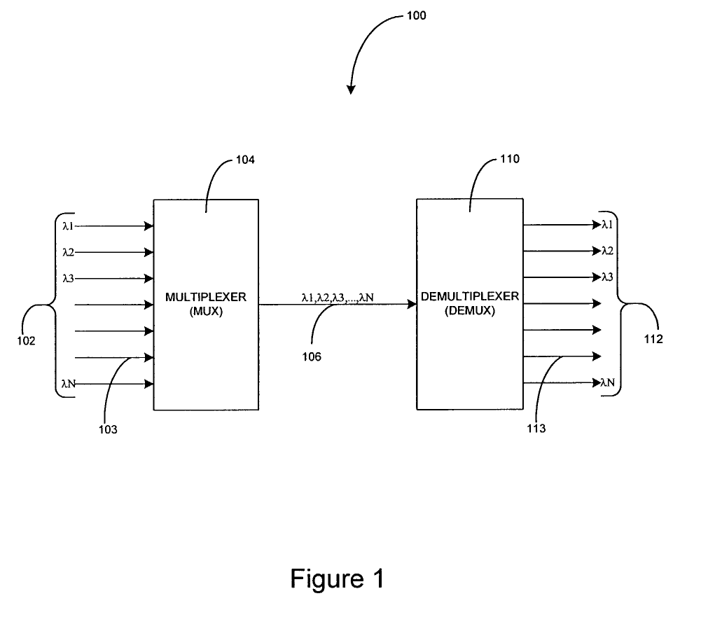

Reference will now be made to the drawings wherein like numerals refer to like parts throughout. FIG. 1 schematically illustrates a dense wavelength division multiplexing (DWDM) system 100 comprising an array 102 of inputs which receive N input signals 103, a multiplexer 104 which outputs a single multiplexed signal 106, a demultiplexer 110 which receives the multiplexed signal 106, and an array 112 of outputs which output N output signals 113. The N output signals 113 that comprise the array of output signals 112 have different wavelengths corresponding to those of the N input signals 103, respectively. The multiplexed signal 106 comprises a combination of all of the N input signals 103, and is carried through a single waveguide so as to effectively multiply the signal carrying capacity by a factor of N.

The demultiplexer 110 demultiplexes or separates the multiplexed signal 106 into the output signals in a manner described below. It will be appreciated that the DWDM system 100 is symmetric such that the direction of the signals can be reversed. That is, the demultiplexer can be used as a multiplexer, and the multiplexer can be used as a demultiplexer.

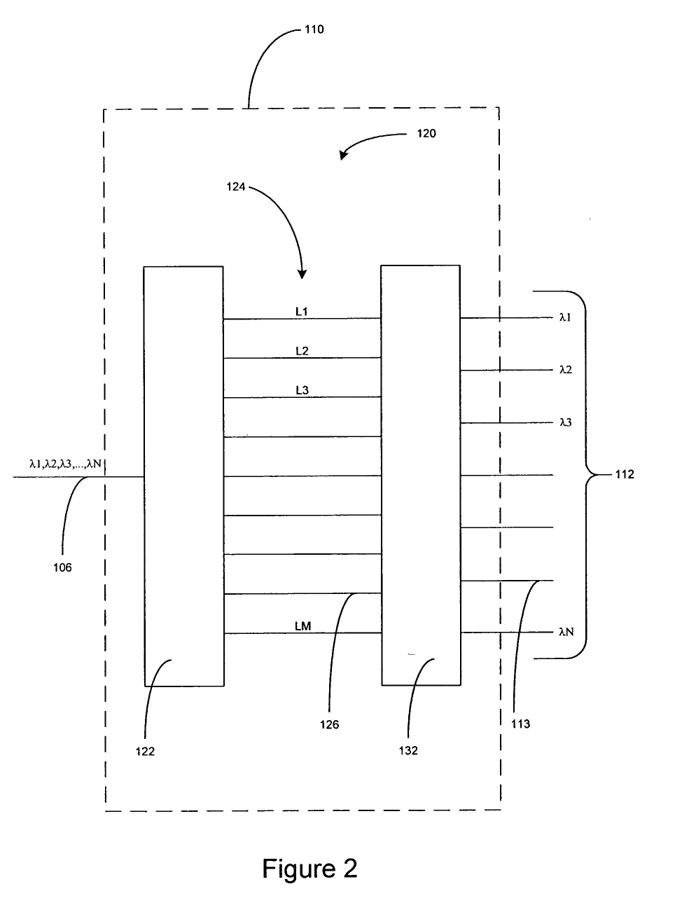

As shown in FIG. 2, the demultiplexer 110 receives the multiplexed signal 106 as an input, passes the signal through an arrayed waveguide grating (AWG) 120, and outputs signals on the output signal array 112. The AWG comprises a first coupler 122, and a waveguide array 124 comprising M individual waveguides 126 of varying optical lengths, where M typically equals N. The first coupler 122 receives the input multiplexed signal 106 and splits its optical energy among the M waveguides 126 in the waveguide array 124 to provide Mmultiplexed signals.

The AWG also comprises a second coupler 132 which receives light from the waveguide array 124. Each of the individual waveguides 126 in the array 124 has a different optical length that provides a correspondingly different optical path. The optical path differences are selected to cause the wavelengths to spatially separate at the second coupler 132 due to interference effects. The second coupler 132 outputs the spatially separated wavelengths to their assigned output signal waveguides 113.

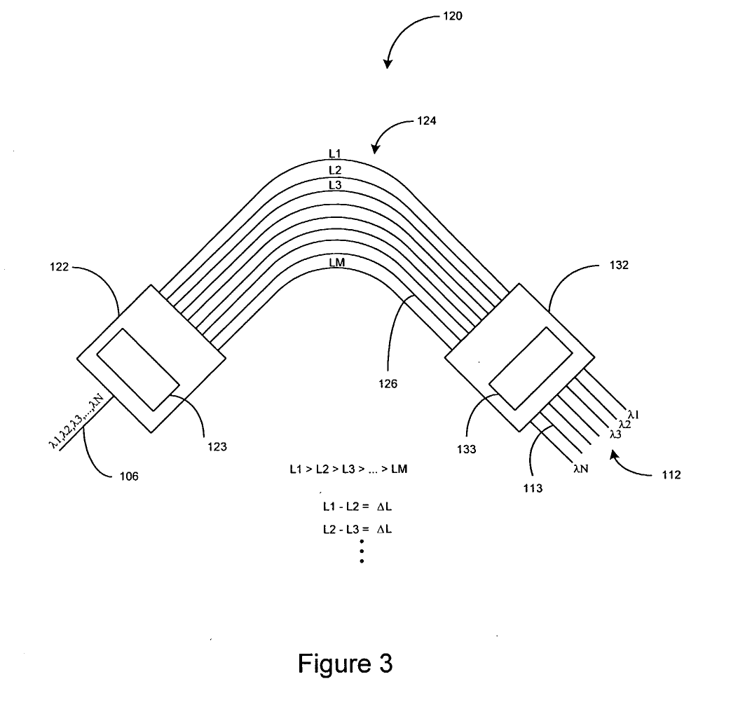

FIG. 3 illustrates, in particular, the variations in lengths of the waveguides 126 used in the AWG 120. The M waveguides 126 shown are arranged in a coplanar manner such that the length of the first waveguide L1 is larger than the length of the second waveguide L2 by an amount ΔL. The L2 is in turn longer than L3 by ΔL, and so on. The multiplexed signal 106 is distributed in the first coupler 122 by a first coupler assembly 123 to the waveguide array 124.

The M multiplexed signals all share a common degree of incoherence due to the multiplexed signal 106 having gone through the same optical path up to that point. As the signals in the waveguides 126 arrive at the second coupler 132, however, relative phases of each of the M multiplexed signals of each waveguide 126 will be different due to the differences in length of the waveguides 126. The difference in phase between any two of the signals is expressed as:

$$δ = \frac{2 πΛ}{λ} \qquad ( 1 )$$

where λ is the wavelength of light in vacuum and Λ is an optical path difference. In general, an optical path is defined as nL, where n is the refractive index, and L is the physical path length. The difference in optical path length is:

Λ=ΔnL+nΔL (2)

In AWG 120 illustrated in FIG. 3, the waveguides of the array 124 are all fabricated from same dielectric material, such that n is constant. As such, Δn=0, and the optical path difference Λ is equal to nΔL.

As an example, an AWG component manufactured by DERA Electronics of United Kingdom has 101 waveguides 126 packaged into a single unit, with ΔL of 10 micrometers (μm). At such ΔL, and for a dielectric medium with refractive index n=1.5, the difference in optical path length Λ is nΔL=1.5×10=15 μm between two adjacent waveguides 126.

The waveguide array 124 is typically fabricated by creating glass (SiO₂) waveguides 126 directly on a silicon substrate in a manner well known in the art. The difference in the optical path lengths of the waveguides 126 described above introduces change in relative phases such that when the signals enter the second coupler 132, a second coupler assembly 133 allows constructive and destructive interference to occur between the fractions from the waveguide array 124, such that each wavelength is separated from adjacent wavelengths and is placed at its assigned location such that the demultiplexed signal can be transmitted as the array of output signals 112. The couplers 122, 132 act as splitters and combiners and may be symmetric, i.e., the same design can be used as a multiplexer and an demultiplexer, however, the light is propagated through the device in opposite directions to achieve the different functionalities.

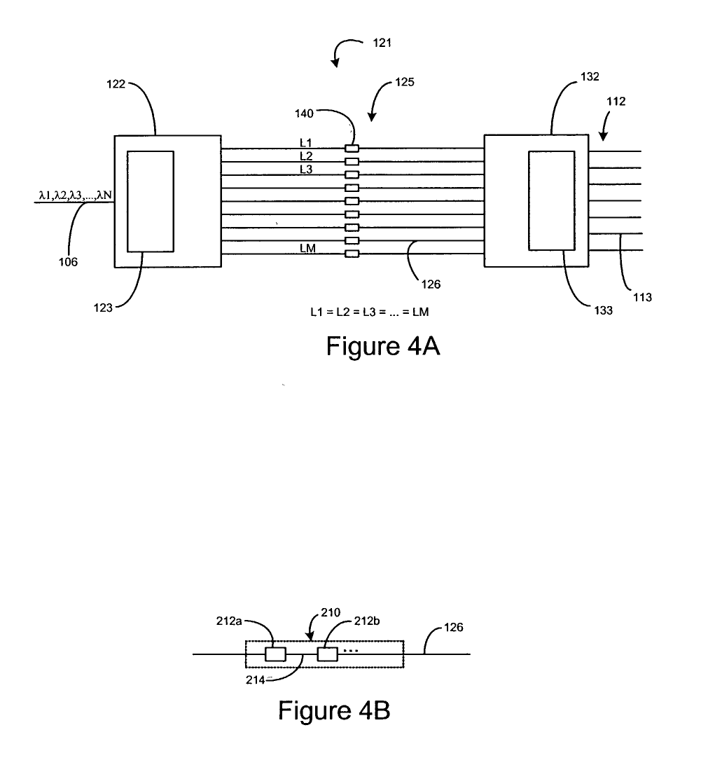

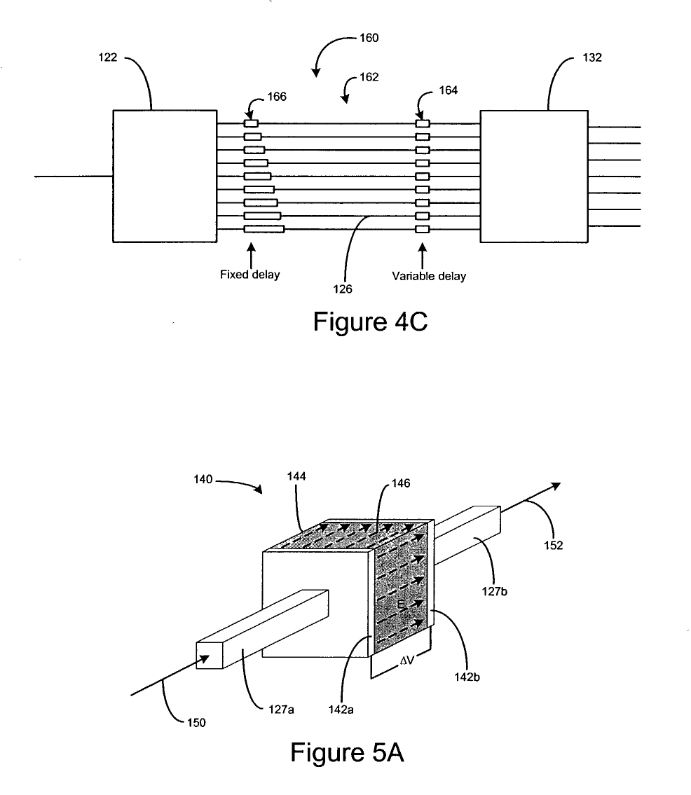

FIG. 4A schematically illustrates one preferred AWG 121 comprising a waveguide array 125 in which the physical lengths of the waveguides 126 of the AWG are all substantially equal to each other. The variations in optical path length through the waveguides 126, A, are introduced by respective electro-optic delay modules 140. This electro-optic delay module 140 may comprise a portion of electro-optic material surrounded on opposite sides by electrodes for inducing an electric field therein. Light propagating through this element 140 is delayed by varying the index of refraction of the electro-optic material with application voltage across the electrodes.

FIG. 4B illustrates another embodiment of a delay module 210 that comprises a two or more electro-optic elements 212a, 212b, etc. (two shown) serially interconnected by waveguides 213. The electro-optic elements 212 of the delay module 210 may have substantially same delaying properties or each of the electro-optic elements 212 may have a different delaying property. While increased delaying of optical signals can be achieved by use of a larger dimensioned electro-optic element, divergence losses increase in such an electro-optic element in the case where the element is a free-space device. Preferably, the electro-optic element 212 has dimensions sufficiently large that the light propagating therethrough is unguided and propagates as if in free space. The boundaries of the device 212 do not limit the propagation of the light therein, which travels in a free space region and is not guided as if in a waveguide that confines the beam therein. Additional details regarding free space devices are included in copending U.S. Patent Application No. ______ (TOPTICS.004CP4) entitled “Optical Switching Network and Network Node and Method of Optical Switching”, filed Romanovsky on May 6, 2006, now U.S. Pat. No. ______, which is incorporated herein by reference in its entirety. Accordingly, within this free space optical device, the beam of light passing therethrough will diverge. To limit this divergence within the electro-optic materal, the electro-optic elements 212 are optically coupled together via waveguides which include reflecting boundaries for containing the light therein. Hence, use of waveguides to interconnect two or more electro-optics modules in series allow increased delaying of optical signals with lower divergence loss. This delay module 210 may be included one or more or each of the M waveguides 126 of the AWG described above in reference to FIG. 4A.

FIG. 4C illustrates another embodiment of an AWG 160 that comprises a waveguide array 162 interconnecting the first and second couplers 122, 132. The waveguide array 162 comprises a plurality of waveguides 126, wherein optical path length through each of the waveguides 126 is determined in part by a fixed delay module 166 in series with a variable delay module 164. The variable delay module 164 may be the single-element delay module 140 of FIG. 4A, or the multi-element delay module 210 of FIG. 4B. The fixed delay module 166 may be formed from, by way of example, a PLZT element without electrodes.

In one embodiment, the fixed delay modules 166 may be substantially the same for all of the waveguides 126. Alternatively, as shown in FIG. 4C, the fixed delay module 166 may differ for each waveguide. The delaying property of a given fixed delay 166 module is determined in part by the material, i.e., its index of refraction, and the length of the optical element, which together determine the optical path length of the device 166. Thus, the different fixed delay modules 166 depicted in FIG. 4C may be formed using different materials and/or different lengths. In one preferred embodiment, the fixed delay element 166 has a length that is different for adjacent waveguides 126. The amount of delay may, for example, be increased sequentially for a sequence of spatially separated outputs. FIG. 4C depicts the fixed delay increasing sequentially for a sequence of optical waveguides having outputs that feed into the second coupler 132. This sequentially increasing fixed delay may be provided by fixed delay elements with increasing length.

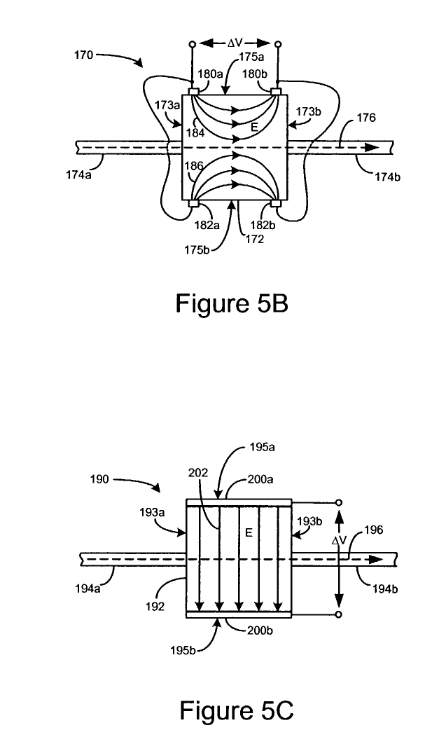

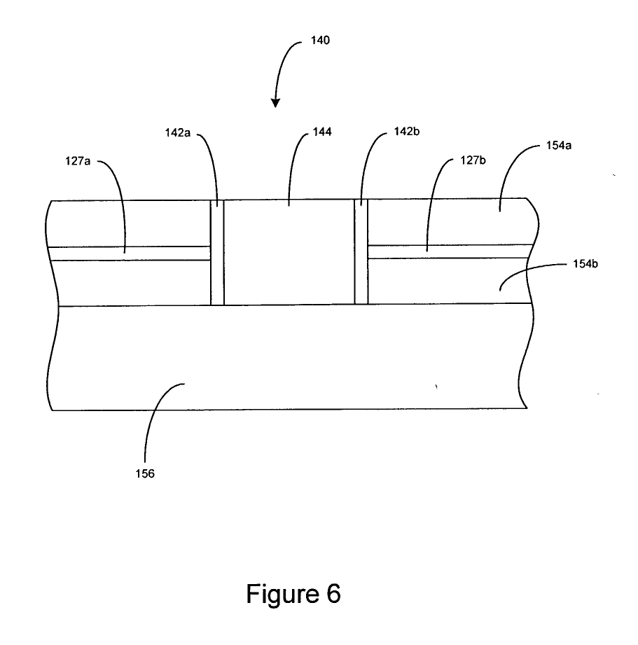

In one preferred embodiment of the invention, as illustrated in FIG. 5A, the electro-optic delay module 140 is interposed between first and second waveguide segments 127a, 127b, respectively, such that light propagating in one of the segments passes through the module 140 and into the other segment. The modules 140 comprise an electro-optic material 144 interposed between a first transparent electrode 142a and a second transparent electrode 142b. The first transparent electrode 142a is between the electro-optic material 144 and an end of the first waveguide segment 127a. The second transparent electrode 142b is between the electro-optic material 144 and an end of the second waveguide segment 127b. A light beam 150 propagating through the first waveguide 127a passes through the first transparent electrode 142a, then the electro-optic material 144, and then the second transparent electrode 142b before entering the second waveguide 127b as a phase-delayed light beam 152. The phase delay introduced by the electro-optic material 144 may be selected to allow demultiplexing of the multiplexed signal in a manner substantially similar to that described above using the conventional AWG device.

As illustrated in FIG. 5A, the phase delay is produced by an electrical field 146 in the electro-optic material 144. The field 146 is generated by applying a bias voltage ΔV between the transparent electrodes 142a and 142b. In one preferred embodiment of the invention, the transparent electrodes 142a and 142b are comprised of an indium tin oxide layer. Additionally, the two transparent electrodes 142a and 142b are arranged in a substantially parallel configuration to provide a substantially uniform electric field parallel to the direction of propagation of the light beams 150, 152 in the central region of the electro-optic delay module 140. This parallel arrangement allows the electro-optic material 144 to delay the light beam 150 independent of polarization.

FIG. 5B illustrates another design of an electro-optic delay module 170 that also delays the optical signal by applying an electric field substantially along a direction of propagation 176. The delay module 170 comprises a portion of electro-optic material 172 having proximal and distal ends 173a, 173b and preferably having a top and bottom 175a, 175b. An input waveguide 174a is attached to the proximal end 173a and an output waveguide 174b is attached to the distal end 173b. A direction of propagation 176 is defined in part by the placement of the input and output waveguides 174a and 174b. Light coupled into the input waveguide 174a propagates through the portion of electro-optic material 172 largely in the direction of propagation 176 to the output waveguide 174b.

The delay module 170 further comprises electrodes disposed at each of the proximal and distal ends 173a and 173b so as to enable an electric field to be produced that is substantially parallel to the direction of propagation 176 of the light through the electro-optic delay element 170. In one preferred embodiment, these electrodes are located on corners or edges of the portion the electro-optic material 172 on the top and bottom 175a, 175b of the delay element 170 near the proximal and distal ends 173a and 173b. In an alternative preferred embodiment, these electrodes may be placed on sides of the electro-optic portion 172 adjacent or near the proximal and distal ends 173a and 173b. In the cross-sectional view shown in FIG. 5B, for example, a positive terminal is connected to an electrode 180a at the top left corner of the electro-optic material 172 and to an electrode 182a at the bottom left corner. A negative terminal is connected to an electrode 180b at the top right corner and to an electrode 182b at the bottom right corner.

A bias voltage ΔV is applied between the positive and negative terminals thereby generating an electric field extending between the proximal and the distal ends 173a and 173b of the electro-optic portion 172. Because the electrodes 180a, 180b, 182a, 182b are placed on opposite ends 173a and 173b of the electro-optic portion 172, as defined by the input and output waveguides 174a and 174b and the propagation of the light within the delay module 170, the resulting electric fields 184 and 186 have a substantial component aligned with the propagation direction 176.

Some electro-optic materials, such as PLZT, are birefringent; the index of refraction varies differently depending on the direction of the applied electric field. In PLZT, for example, the index of refraction decreases for light polarized parallel to the applied electric field and increases for light polarized perpendicular to the electric field. The magnitude of this increase for perpendicular polarization states is also about one-third as large as the decrease for parallel polarizations. See, for example, copending U.S. Patent Application No. ______ (TOPTICS.004CP4) entitled “Optical Switching Network and Network Node and Method of Optical Switching”, filed Romanovsky on May 6, 2006, now U.S. Pat. No. ______, which is incorporated herein by reference in its entirety. By providing an electric field substantially aligned with the propagation direction of the light, the electric field will be substantially perpendicular to the polarization of the light regardless of its polarization state. Light will therefore not experience a different polarization depending on its polarization, and thus, a polarization-independent delay can be provided.

FIG. 5C illustrates another embodiment of an electro-optic delay module 190 that is polarization-dependent, i.e., the amount of delay depends on the polarization of the optical signal passing through the device 190. The module 190 comprises a portion of electro-optic material 192 having proximal and distal ends 193a, 193b and preferably having a top and bottom 195a, 195b. An input waveguide 194a is attached to the proximal end 193a and an output waveguide 194b is attached to the distal end 193b. A direction of propagation 196 is defined in part by the placement of the input and output waveguides 194a and 194b. Light coupled into the input waveguide 194a propagates through the portion of electro-optic material 192 largely in the direction of propagation 196 to the output waveguide 194b. In the embodiment depicted in FIG. 5C, first and second substantially planar electrodes 200a, and 200b are on the top and bottom 195a, 195b, respectively, of the portion of electro-optic material 192. The first and second electrodes 200a, 200b are preferably parallel to each other, and with respect to the top and bottom faces 195a, 195b of the electro-optic material 192. In alternative embodiments, these electrodes may be on opposite sides or sidewalls of the portion of electro-optic material 192.

When a bias voltage ΔV is applied between the first and second electrodes 200a, 200b, an electric field 202 that is transverse to the direction of propagation 196 is induced within the electro-optic portion 192. Accordingly, light comprising transverse electromagnetic waves having an arbitrary polarization may include polarization components parallel and/or perpendicular to the applied electric field. Because of the birefringent behavior of some electro-optic material 192 (such as PLZT) as described above, polarization components parallel to the electric field will experience a different index of refraction and a different amount of phase delay than perpendicular polarization components when propagating through the delay module 190. Accordingly, the delay introduced by the module 190 depends on the polarization of the optical signal. Such features may be utilized advantageously if the incoming optical signal has a given polarization.

In one preferred embodiment of the invention, the electro-optic material 144 is a polycrystalline lanthanum-modified lead titanate zirconate (PLZT). FIG. 6 illustrates the electro-optic module 140 fabricated on a silicon substrate 156. Using silicon fabrication methods well known in the art, a bottom SiO2 layer 154b and a top SiO2 layer 154a are formed with the first waveguide segment 127a and the second waveguide segment 127b interposed therebetween. The first transparent electrode 142a, the electro-optic material 144, and the second transparent electrode 142b are formed by filling a groove as shown in FIG. 6.

PLZT is an electro-optic material which has a refractive index n that depends on the electric field 146. The velocity of propagation of light in a dielectric medium is given by v=c/n, where c is a constant velocity of light in vacuum. By changing the electric field strength in the electro-optic material 144, the velocity of propagation v can be controlled, thus allowing controllable variations in delays of the light signals in the waveguide array 125. Preferably, the electro-optic delay module 140 can delay the phase of the light beam 150 by at least 2π radians, which is one full wavelength. As indicated above, 15 μm is a typical difference in the optical path length between the adjacent waveguides 126 of the example conventional AWG 120. For a light with wavelength of 1550 nM, the corresponding phase delay δ, according to Eq. 1, is about 10×(2π). In the AWG 121 of the preferred embodiment described above, the waveguides comprised of the waveguide array 125 have substantially same physical length. As such, the difference in optical path length Λ is given by Δn L′ from Eq. 2, where L′ in this case is the physical length of the electro-optic material 144 through which the light travels. If a user selects a Λ of 15 μm, as in the example, then L′=(15/Δn) μm. As is well known in the art relating to PLZT, Δn of 0.010 is an easily obtainable value. Using this number for Δn, L′ is calculated to be 1500 μm, or 1.5 mm. This dimension for L′ corresponds to phase delay of about 10 cycles when using light with wavelength of 1550 nm. The dimension for L′ can be as small as 150 μm, which corresponds to phase difference of 2π radians, or one full wavelength. This length, L′, can be that of a single delay element or of multiple (fixed and/or variable) delay elements optically coupled together as described above.

The use of electro-optic material 144 thus allows delaying of optical signals, with the amount of delay comparable to that in the conventional AWG devices. Furthermore, the use of electro-optic material 144 allows the amount of delay to be tuned by changing the bias voltage applied to the transparent electrodes 142a and 142b. The tuning feature allows the user to adjust the AWG 121 to compensate for variations due to manufacturing tolerances and environmental factors. Furthermore, since each of the electro-optic delay modules 140 can be tuned independently, the AWG 121 as a whole can be configured in a variety of ways to suit the needs of the user. It will also be appreciated that the AWG 121 can be used in reverse as a multiplexer, as referred to above. Similarly, the delay modules or -elements themselves are bidirectional, imparting adjustable amounts of phase delay unto light propagating in either direction therethrough. It will also be understood that, although the AWG 121 preferably utilizes waveguides of equal length (so that all of the delay differentials are due to the electro-optic material), in an alternative embodiment, the delay may be provided in part by waveguides of unequal length and in part by electro-optic material.

Although the foregoing description of the preferred embodiment of the present invention has shown, described and pointed out the fundamental novel features of the invention, it will be understood that various omissions, substitutions and changes in the form of the detail of the apparatus as illustrated, as well as the uses thereof, may be made by those skilled in the art without departing from the spirit of the present invention. Consequently, the scope of the invention should not be limited to the foregoing discussion, but should be defined by the appended claims.

What is claimed is:

1. An electro-optic arrayed grating, comprising:
a first coupler;
a second coupler;
an array providing a plurality of optical paths between the first and second couplers, said array comprising a plurality of electro-optic elements along said optical paths, said electro-optic elements controlling optical path lengths of said optical paths, respectively to multiplex or demultiplex an optical signal.

2. The electro-optic arrayed grating of claim 1, wherein said electro-optic elements comprises an electro-optic material interposed between a pair of electrodes.

3. The electro-optic arrayed grating of claim 2, wherein the electro-optic material comprises polycrystalline lanthanum-modified lead titanate zirconate (PLZT).

4. The electro-optic arrayed grating of claim 2, wherein said electrodes in said pair are disposed proximal opposite ends the electro-optic elements such that an electric field between the electrodes is substantially parallel said optical path.

5. The electro-optic arrayed grating of claim 4, wherein at least one of said optical paths extends through the electrodes.

6. The electro-optic arrayed grating of claim 5, wherein the electrodes comprise indium tin oxide.

7. The electro-optic arrayed grating of claim 4, wherein a first pair of electrodes is disposed on one side of said electro-optic element, said first pair of electrodes including electrical terminals for applying a voltage across said first pair to induce an electric field through said electro-optic material.

8. The electro-optic arrayed grating of claim 8, wherein a second pair of electrodes is disposed an opposite side of said electro-optic element, said second pair of electrodes including electrical terminals for applying a voltage across said second pair to inducing an electric field through said electro-optic material.

9. The electro-optic arrayed grating of claim 9, wherein said first and second pair of electrodes are on top and bottom of said electro-optic element.

10. The electro-optic arrayed grating of claim 2, wherein said pair of electrodes are on top and bottom of said electro-optic element such that an electric field substantially directed from top to bottom can be induced through said electro-optic material.

11. The electro-optic arrayed grating of claim 1, wherein the array comprises a plurality of waveguides that provide the plurality of optical paths.

12. The electro-optic arrayed grating of claim 1, wherein a plurality of optical of electro-optic elements are included, along one of said optical paths, said electro-optic elements being optically connected together by optical waveguides.

13. The electro-optic arrayed grating of claim 1, further comprising a fixed delay element in said optical path, said fixed delay element introducing an amount of phase delay to said optical signal propagating through said optical path.

14. The electro-optic arrayed grating of claim 13, wherein the fixed delay element comprises an electro-optic material without electrodes.

15. The electro-optic arrayed grating of claim 13, wherein said fixed delay element comprises PLZT.

16. The electro-optic arrayed grating of claim 1, further comprising a plurality of fixed delay elements in said optical paths, said fixed delay elements introducing different amounts of fixed delay in different optical paths.

17. A method of demultiplexing an optical signal comprised of a plurality of wavelengths, comprising:
distributing said optical signal into a plurality of optical signals, each of which includes said plurality of wavelengths;
delaying the plurality of optical signals by propagating said plurality of signals along respective optical paths, at least some of the paths having a different optical path length than other of the paths, said propagating comprising passing said plurality of optical signals through electro-optic material such that each of said plurality of signals is delayed by the electro-optic material;
combining the plurality of delayed signals, said combining comprising utilizing the delay of said delayed signals to spatially separate said plurality of wavelengths.

18. The method of claim 17, wherein the physical path lengths of the optical paths are substantially equal.

19. The method of claim 17, wherein the delaying further comprises providing an electric field in the electro-optic material, the electric field in a direction substantially parallel to the direction of propagation of the optical signal through the electro-optic material.

20. The method of claim 19, comprising passing the plurality of optical signals through respective electrodes disposed on opposite sides of the electro-optic material.

21. The method of claim 19, wherein each of the delays of the delayed signals is adjustable by adjusting a voltage applied between said electrodes.

22. The method of claim 21, comprising altering the spatial separation of wavelengths by altering the voltages applied to the electrodes.

23. The method of claim 17, wherein the delaying further comprises providing an electric field in the electro-optic material, the electric field in a direction substantially perpendicular to the direction of propagation of the optical signal.

24. The method of claim 23, comprising applying a voltage to electrodes disposed on opposite lateral sides of the electro-optic material.

25. The method of claim 17, wherein said optical signals are propagated through regions comprising a fixed optical delay and regions for imparting variable phase delay along said respective optical paths, said variable phase delay being imparted by adjusting the electric field through said electro-optic material in said optical path and said fixed optical delay being different for respective optical paths.

26. A phase delay device for introducing phase delay into an optical signal, said device comprising:
a plurality of electro-optic elements along a path, said electro-optic elements comprising an electro-optic material interposed between a pair of electrodes, said electro-optic element having dimensions such that said optical signal propagating therethrough is unguided within said electro-optic element;
a plurality of optical waveguides optically connecting said electro-optic elements together, said waveguides and electro-optical element together forming an optical path for said optical signal;
wherein said electro-optic elements control the optical path lengths of said optical paths and said waveguides limit divergence of said optical signal.
